(19) United States
(12) Patent Application Publication
(10) Pub. No.: US 2005/0062783 A1
(43) Pub. Date: Mar. 24, 2005

(54) Method and apparatus for detecting a pixel distance to adjust a threshold value

(76) Inventors: Ki-min Kang, Seongnam-si (KR); Goo-Soo Gahang, Yongin-si (KR); Choon-woo Kim, Seoul (KR); Hyeon-seok Seo, Incheon Metropolitan-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/885,897

(22) Filed: Jul. 8, 2004

(30) Foreign Application Priority Data
Jul. 9, 2003 (KR) 2003-46320

(51) Int. Cl. B41J 29/393

(52) U.S. Cl. 347/19

(57) ABSTRACT

A method of and apparatus for detecting a pixel distance to adjust a threshold value are disclosed. The method and apparatus include determining a first coordinate of a first pixel with reference to a minor pixel for each pixel of an image, and detecting a first pixel distance which corresponds to a distance between the first pixel and the minor pixel by using the determined first coordinate, wherein the first pixel is binarized by adjusting a threshold value based on the detected first pixel distance, and the first coordinate is reset when the binarized first pixel is determined to be the minor pixel.

### CROSS-REFERENCE TO RELATED APPLICATIONS

This application claims the benefit under 35 U.S.C. § 119(a) of Korean Patent Application No. 2003-46320, filed on Jul. 9, 2003, in the Korean Intellectual Property Office, the contents of which is incorporated herein in its entirety by reference.

### BACKGROUND OF THE INVENTION

1. Field of the Invention

The present invention relates to improving an image quality of an image printed by a printer. More particularly, the present invention relates to a method and apparatus for detecting a pixel distance to adjust a threshold value used for binarization of image pixels by detecting a distance up to a minor pixel.

2. Description of the Related Art

In general, an image having brightness values between 0 (black color) and 255 (white color) is referred to as a continuous gray scale image. A printer reproduces only two gray scales corresponding to whether or not a print dot for a gray scale image is printed on a print medium. Therefore, in order to receive a 256 gray scale image, which is a monitor-oriented image, as an input or output signal to or from the printer, a binary converting means is needed. One such method is a halftone method used for reproducing the continuous gray scale image using only the gray scales 0 and 256. An image generated by using the halftone method is called a binary image. An error diffusion method is one of the halftone methods which has been widely used in the prior art.

The error diffusion method is a method in which the continuous gray scale image is binarized by using a threshold value of a predetermined pixel and then errors generated during the binarization are propagated to adjacent pixels. The error diffusion method is classified as part of the Floyd-Steinberg method and the minor pixel offset array (MPOA) method.

The Floyd-Steinberg method comprises a section for adding an input gray scale value to errors propagated from the adjacent pixels, a section for binarizing the added value into a fixed threshold value, and a section for propagating the binarized errors to other adjacent pixels which are subjected to binarization. For example, assuming that the threshold value is 128, when the error-added value is larger than the fixed threshold value, that is, 128, the gray scale 255 is output, and when the error-added value is smaller than the fixed threshold value, the gray scale 0 is output. As a result, the binary image is obtained. Image quality of the binary image depends on the reproducibility of gray scales and the creation of unpleasant patterns in the binary image.

In particular, the human eye is insensitive to a high frequency component of light, but greatly sensitive to a lower frequency component of light. Moreover, the binary image has a lower spatial resolution, and representing a white point in a dark region and a black point in a bright region is more perceptible to the human eye than an image having a halftone gray scale. Therefore, the distribution of the binary pixels in the dark region or the bright region is a principal factor in the image quality of the binary image. Since such a binary image is represented with only the two states corresponding to the black and white points, the quality of the printed image is determined according to the distribution of the black and white points.

However, since the error propagation is asymmetrically performed in the Floyd-Steinberg method, the distribution of the binarized print dots is so irregular that unpleasant patterns may be formed, and additionally, the so-called “worm artifacts,” that is, a particular pattern where points are flowing down in the bright and dark regions, may be generated.

In the MPOA method, the binary image is obtained by using a threshold value which varies according to the input gray scales, unlike the Floyd-Steinberg method in which a fixed threshold value is used. In the MPOA, an ideal pixel distance between a currently-to-be-binarized pixel and a minor pixel is firstly obtained. The ideal pixel distance is an ideal distance maintained between the to-be-binarized pixel and adjacent dots in order that the input gray scale image can have a uniform distribution of uniform-interval print dots after its binarization. When more white points than black points exist, the black points become the minor pixels. In this case, the image quality of the binary image is determined according to the distribution of the black points, that is, the minor points.

In contrast, when more black points than white points exist, the white points become the minor pixels. Thus, the image quality of the binary image is determined according to the distribution of the white points, that is, the minor points. After the ideal pixel distance is obtained, the real pixel distance is obtained. The real pixel distance is a distance from the to-be-binarized pixel to a minor pixel of the nearest region among the adjacent regions which are binarized in advance.

A varied threshold value is obtained from the following equation 1 by using the ideal pixel distance and the real pixel distance.

$$\begin{matrix}T = 128 + ( {d}_{min}^{2} - {r}_{p}^{2} ) & if p \geq 128 \\ 128 + ( {r}_{p}^{2} - {d}_{min}^{2} ) & if p < 128\end{matrix} \qquad Equation 1$$

Herein, dₘᵢₙ² indicates a nearest real pixel distance between a predetermined pixel at a to-be-binarized point p and a minor pixel which is binarized in advance, rₚ² indicates an ideal pixel distance between the predetermined pixel at the point p and the minor pixel which is binarized in advance. When the gray scale value of the predetermined pixel at the point p is larger than 128, the threshold value is obtained by using the higher value in equation 1, when the gray scale value of the predetermined pixel at the point p is smaller than 128, the threshold value is obtained by using the second relationship in equation 1. According to the MPOA, the threshold value varies by calculating the real distances of the print dots in the adjacent regions, so that the print dots do not generate any eye-unpleasant patterns and the uniform distribution of pixels can be implemented.

In order to obtain the threshold value that was changed by using the aforementioned equation 1, it is necessary to obtain the real pixel distances between the to-be-binarized predetermined pixel and the minor pixels which are binarized in advance.

In one of the conventional methods, all the distances between the to-be-binarized predetermined pixel and all the adjacent pixels thereof are retrieved and then the distance from the predetermined pixel to the nearest minor pixel is obtained.

In another method, instead of retrieving all the distances between the to-be-binarized predetermined pixel and all the adjacent pixels thereof, information on distances from the predetermined pixel to all the minor pixels is pre-stored in a memory and the real pixel distances are retrieved therefrom.

However, in the MPOA method, a large number of real pixel distances must be stored in the memory in order to calculate the distances between the predetermined pixel and the minor pixels and the process for determining the nearest real pixel distance from the predetermined pixel among the stored real pixel distance is needed. Therefore, the MPOA method is computationally expensive and time-consuming.

### SUMMARY OF THE INVENTION

The present invention provides a method of detecting a pixel distance to adjust a threshold value by detecting a real pixel distance up to a minor pixel.

The present invention also provides an apparatus for detecting a pixel distance to adjust a threshold value by detecting a real pixel distance up to a minor pixel.

According to an aspect of the present invention, there is provided method of detecting a pixel distance to adjust a threshold value which is performed in a printer. The method comprises determining a first coordinate of a first pixel with reference to a minor pixel for each pixel of the image; and detecting a first pixel distance which corresponds to a distance between the first pixel and the minor pixel by using the determined first coordinate, wherein the first pixel is binarized by adjusting a threshold value based on the detected first pixel distance, and the first coordinate is reset when the binarized first pixel is determined to be the minor pixel

According to another aspect of the present invention, there is provided an apparatus for detecting a pixel distance to adjust a threshold value which is performed in a printer. The apparatus comprises a coordinate determination unit, for determining a first coordinate of a first pixel with reference to a minor pixel for each pixel of the image; and a pixel distance detection unit, for detecting a first pixel distance between the first pixel and the minor pixel by using the determined first coordinate, wherein the predetermined pixel is binarized by adjusting a threshold value based on the detected first pixel distance, and the first coordinate is reset when the binarized first pixel is determined to be the minor pixel by the coordinate determination unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method for detecting a pixel distance to adjust a threshold value in accordance with an embodiment of the present invention;

FIG. 2 is a table illustrating a state in which coordinates of pixels in each line of the image are determined along a binarization direction;

FIG. 3 is a table illustrating coordinates of a first pixel and adjacent pixels located above and at sides of the first pixel;

FIG. 4 is a flowchart illustrating in greater detail step 10 shown in FIG. 1 in accordance with an embodiment of the present invention;

FIG. 5 is a block diagram illustrating an example of an apparatus for detecting a pixel distance in order to adjust a threshold value in accordance with an embodiment of the present invention; and

FIG. 6 is a block diagram illustrating a coordinate determination unit shown in FIG. 5 in accordance with an embodiment of the present invention.

Throughout the drawings, it should be noted that the same or similar elements are denoted by like reference numerals.

### DETAILED DESCRIPTION OF THE INVENTION

A method of detecting a pixel distance to adjust a threshold value according to the present invention will be described with reference to the accompanying drawings.

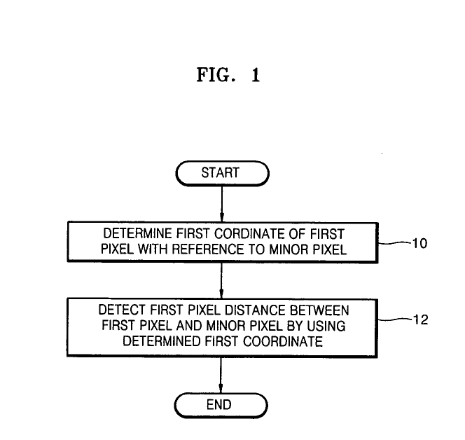

FIG. 1 is a flowchart illustrating a method for detecting a pixel distance to adjust a threshold value in accordance with an embodiment of the present invention. The method comprises steps 10 and 12 for detecting a first pixel distance by using a determined first coordinate.

Firstly, in step 10, a first coordinate of a first pixel is determined with reference to a minor pixel for each pixel of an image.

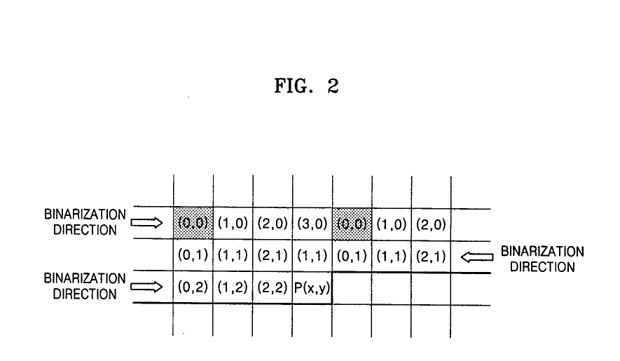

FIG. 2 is a table illustrating a state in which coordinates of pixels in each line of the image are determined along a binarization direction. The binarization is performed from the left to right on a line of the image, and then from the left to right on the next line of the image. The binarization is repeatedly performed. As a result, the coordinates are determined sequentially from left to right on one line of the image, and the coordinates are determined sequentially from right to left on the next line of the image. However, in other embodiments of the present invention, the coordinates may be determined along the same direction for all lines.

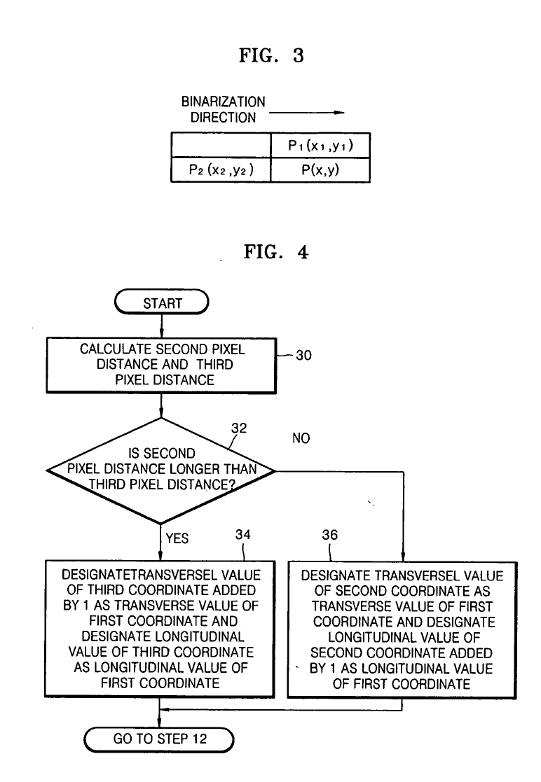

The first coordinate is determined using a second coordinate of an upper pixel located above the first pixel and a third coordinate of a side pixel located at one side of the first pixel. FIG. 3 is a table illustrating coordinates of a first pixel P which is subjected to the binarization and adjacent pixels P1 and P2, which are located above and at the sides of the first pixel. The first coordinate (x, y) of the first pixel P is determined using a first coordinate (x1, y1) of the pixel P1, which is located just above the first pixel P and a third coordinate (x2, y2) of the pixel P2 of which coordinate is determined in advance, among the pixels which are located in the same line which the first pixel is located in. For example, in FIG. 2, the coordinate of the upper pixel P1 of the first pixel P is (0, 1), and the coordinate of the side pixel P2, which is located at the left side of the first pixel P is (2, 2). Since the coordinate of the pixel located at the right side of the first pixel P is not yet determined, the pixel is not a side pixel.

FIG. 4 is a flowchart illustrating in greater detail step 10 shown in FIG. 1 in accordance with an embodiment of the present invention. Step 10 comprises steps 30 to 36 for comparing a second pixel distance with a third pixel distance and designating the first coordinate.

Firstly, in step 30, a second pixel distance which corresponds to a distance between the upper pixel and the minor pixel and a third pixel distance which corresponds to a distance between the side pixel and the minor pixel are calculated. As shown in FIGS. 2 and 3, assuming that the second coordinate of the upper pixel P1 and the third coordinate of the side pixel P2 are (1, 1) and (2, 2), respectively, the second pixel distance D1 and the third pixel distance D2 are obtained from the following equations 2 and 3.
D₁=\sqrt{(x₁²+y₁²)} Equation 2
D₂=\sqrt{(x₂²+y₂²)} Equation 3

In other words, the second pixel distance obtained from equation 2 is D1=\sqrt{2}, and the third pixel distance obtained from equation 3 is D2=2\sqrt{2}.

After step 30, it is determined whether the second pixel distance is longer than the third pixel distance, as shown in step 32. Whether the second pixel distance is longer or not than the third pixel distance is determined using the second and third pixel distances obtained in step 30.

If the second pixel distance is determined to be longer than the third pixel distance, in step 34, a transverse value of the third coordinate added by 1 is designated as a transverse value of the first coordinate and a longitudinal value of the third coordinate is designated as a longitudinal value of the first coordinate. For example, assuming that the second and third coordinates are (2, 0) and (1, 1), respectively, the second pixel distance D1 of the second coordinate is 2, and the third pixel distance D2 of the third coordinate is \sqrt{2}. As a result, since the second pixel distance D1 is longer than the third pixel distance D2, the transverse value of the first coordinate becomes 2, which is the transverse value of the third coordinate added by 1, and the longitudinal value of the first coordinate is 1, which is the longitudinal value of the third coordinate. Accordingly, the first coordinate (x, y) of the first pixel P is (2, 1).

However, if the second pixel distance is determined not to be longer than the third pixel distance, in step 36, a transverse value of the second coordinate is designated as a transverse value of the first coordinate and a longitudinal value of the second coordinate added by 1 is designated as a longitudinal value of the first coordinate. For example, assuming that the second and third coordinates are (1, 1) and (2, 2), respectively, the second pixel distance D1 of the second coordinate is \sqrt{2}, and the third pixel distance D2 of the third coordinate is 2\sqrt{2}. As a result, since the second pixel distance D1 is shorter than the third pixel distance D2, the transverse value of the first coordinate becomes 1, which is the transverse value of the second coordinate, and the longitudinal value of the first coordinate is 2, which is the longitudinal value of the second coordinate added by 1. Accordingly, the first coordinate (x, y) of the first pixel P is (1, 2).

In contrast, after step 10, a first pixel distance which corresponds to a distance between the first pixel and the minor pixel is detected by using the determined first coordinate, as shown in step 12. For example, assuming that the first coordinate (x, y) of the first pixel is (1, 2), the first pixel distance can be obtained by using equation 2 or 3. In other words, the first pixel distance which corresponds to a distance from the first coordinate of the first pixel P to the minor pixel which is located at the nearest position thereof is equal to \sqrt{5}.

The detected first pixel distance is applied to the aforementioned equation 1, which is used for obtaining the threshold value, so that the adjusted threshold value can be obtained. The first pixel is binarized based on the adjusted threshold value. At this time, if the binarized first pixel is determined to be a minor pixel, the first coordinate obtained from the foregoing processes is reset to (0, 0). As shown in FIG. 2, assuming that a black point is a minor pixel, if the first pixel is binarized as the black point, the first coordinate detected at the first pixel is reset to coordinate (0, 0). In turn, the reset coordinate (0, 0) functions as a minor pixel for second pixel next to the first pixel and becomes a reference which is used for determining the first coordinate of the second pixel.

After the binarization of the first pixel, the aforementioned processes are repeatedly performed on the second pixel.

An apparatus for detecting a pixel distance to adjust a threshold value according to an embodiment of the present invention will be described with reference to the accompanying drawings.

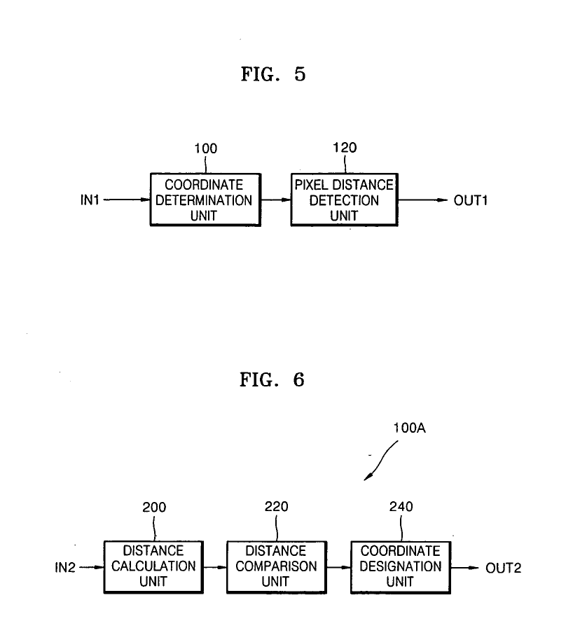

FIG. 5 is a block diagram illustrating an example of an apparatus for detecting a pixel distance in order to adjust a threshold value in accordance with an embodiment of the present invention. The apparatus comprises a coordinate determination unit 100 and a pixel distance detection unit 120.

The coordinate determination unit 100 determines a first coordinate of a first pixel with reference to a minor pixel for each pixel of the image. In response to a binarization request signal which is input through an input terminal IN1, the coordinate determination unit 100 determines the first coordinate of the first pixel with reference to the minor pixel for each pixel of the image which is to be subjected to binarization and outputs the determined result to the distance detection unit 120.

In addition, the coordinate determination unit 100 determines whether the binarized first pixel is a minor pixel, and resets the obtained first coordinate to (0, 0) when the binarized first pixel is the minor pixel.

It is preferable that, in the coordinate determination unit 100, the coordinate be determined from left to right on a line of the image, and then the coordinates be determined from left to right on the next line of the image. However, in other embodiments of the present invention, the coordinates may be determined along the same direction for all lines.

In the coordinate determination unit 100, the first coordinate is determined using a second coordinate of an upper pixel located above the first pixel and a third coordinate of a side pixel located at one side of the first pixel.

FIG. 6 is a block diagram illustrating the coordinate determination unit 100 shown in FIG. 5 in accordance with an embodiment of the present invention. The coordinate determination unit 100A of FIG. 6 comprises a distance calculation unit 200, a distance comparison unit 220, and a coordinate-value designation unit 240.

The distance calculation unit 200 calculates a second pixel distance which corresponds to a distance between the upper pixel and the minor pixel and a third pixel distance which corresponds to a distance between the side pixel and the minor pixel. In response to a binarization request signal which is input through an input terminal IN2, the distance calculation unit 200 calculates the second pixel distance which corresponds to the distance between the upper pixel located above the first pixel and the minor pixel by using the aforementioned equation 2. In addition, the distance calculation unit 200 calculates the third pixel distance which corresponds to the distance between the side pixel and the minor pixel by using the aforementioned equation 3. The calculated second and third pixel distances are output to the distance comparison unit 220.

The distance comparison unit 220 compares the second pixel distance with the third pixel distance and outputs the comparison result. The distance comparison unit 220 compares the second pixel distance which is input from the distance calculation unit 200 with the third pixel distance and outputs the comparison result to the coordinate-value designation unit 240.

In response to the comparison result, the coordinate-value designation unit 240 designates a transverse value of the third coordinate added by 1 as a transverse value of the first coordinate and designates a longitudinal value of the third coordinate as a longitudinal value of the first coordinate, or designates a transverse value of the second coordinate as a transverse value of the first coordinate and designates a longitudinal value of the second coordinate added by 1 as a longitudinal value of the first coordinate.

If the result that the second distance is longer than the third distance is input from the distance comparison unit 220, the coordinate-value designation unit 240 designates the transverse value of the third coordinate added by 1 as the transverse value of the first coordinate, designates the longitudinal value of the third coordinate as the longitudinal value of the first coordinate, and then outputs the first coordinate corresponding to the designated result through an output terminal OUT2.

In addition, if the result that the second distance is not longer than the third distance is input from the distance comparison unit 220, the coordinate-value designation unit 240 designates the transverse value of the second coordinate as the transverse value of the first coordinate and designates the longitudinal value of the second coordinate added by 1 as the longitudinal value of the first coordinate, and then outputs the first coordinate corresponding to the designated result through the output terminal OUT2.

The pixel distance detection unit 120 detects a first pixel distance between the first pixel and the minor pixel by using the determined first coordinate. When the first coordinate is input from the coordinate determination unit 100, the pixel distance detection unit 120 detects a first pixel distance between the first pixel and the minor pixel by using the determined first coordinate, and then outputs the detected result through an output terminal OUT1.

The detected first pixel distance is applied to the aforementioned equation 1, which is used for obtaining the threshold value, so that the threshold value can be adjusted. The first pixel is binarized based on the adjusted threshold value. If the first pixel is binarized as a minor pixel, the coordinate designation unit 240 resets the first coordinate obtained from the foregoing processes to (0, 0). As shown in FIG. 2, when a black point is a minor pixel, the first coordinate is reset to coordinate (0, 0). In turn, the reset coordinate (0, 0) functions as a minor pixel for the second pixel and becomes a reference which is used for determining the first coordinate of the second pixel.

As describe above, by using the method of and apparatus for detecting a pixel distance to adjust a threshold value according to embodiments of the present invention, pictures with better image quality are obtained compared to pictures obtained using the conventional Floyd-Steinberg method. In addition, the method and apparatus according to embodiments of the present invention detect the distance between a to-be-binarized first pixel and a minor pixel more rapidly than in the MPOA method, so that the threshold value can be rapidly calculated and a rapid binarization can be implemented.

While the present invention has been particularly shown and described with reference to exemplary embodiments thereof, it should be understood by those of ordinary skill in the art that various changes in form and details may be made therein without departing from the spirit and scope of the present invention as defined by the following claims.

1. A method for detecting a pixel distance to adjust a threshold value in a printer, the method comprising the steps of:
determining a first coordinate of a first pixel with reference to a minor pixel for each pixel of an image; and
detecting a first pixel distance which corresponds to a distance between the first pixel and the minor pixel by using the determined first coordinate,
wherein the first pixel is binarized by adjusting a threshold value based on the detected first pixel distance, and the first coordinate is reset when the binarized first pixel is determined to be the minor pixel.

2. The method of detecting a pixel distance according to claim 1, wherein, in the determining step further comprises:
performing coordinate determination from the left to right on a line of the image; and
performing coordinate determination from right to left on a next line of the image.

3. The method of detecting a pixel distance according to claim 2, wherein, in the determining step further comprises:
determining the first coordinate using a second coordinate of an upper pixel located above the first pixel and a third coordinate of a side pixel located at one side of the first pixel.

4. The method of detecting a pixel distance according to claim 3, wherein step the determining step further comprises:
calculating a second pixel distance which corresponds to a distance between the upper pixel and the minor pixel and a third pixel distance which corresponds to a distance between the side pixel and the minor pixel;
determining whether the second pixel distance is longer than the third pixel distance;
designating a transverse value of the third coordinate added by 1 as a transverse value of the first coordinate and designating a longitudinal value of the third coordinate as a longitudinal value of the first coordinate when the second pixel distance is determined to be longer than the third pixel distance; and
designating a transverse value of the second coordinate as a transverse value of the first coordinate and designating a longitudinal value of the second coordinate added by 1 as a longitudinal value of the first coordinate when the second pixel distance is determined not to be longer than the third pixel distance.

5. An apparatus for detecting a pixel distance to adjust a threshold value in a printer, the apparatus comprising:
a coordinate determination unit, for determining a first coordinate of a first pixel with reference to a minor pixel for each pixel of an image; and
a pixel distance detection unit, for detecting a first pixel distance between the first pixel and the minor pixel by using the determined first coordinate,
wherein the first pixel is binarized by adjusting a threshold value based on the detected first pixel distance, and the first coordinate is reset when the binarized first pixel is determined to be the minor pixel by the coordinate determination unit.

6. The apparatus for detecting a pixel distance according to claim 5, wherein, in the coordinate determination unit, the coordinate determination is performed from the left to right on a line of the image, and the coordinate determination is performed from the right to left on a next line of the image.

7. The apparatus for detecting a pixel distance according to claim 6, wherein, in the coordinate determination unit, the first coordinate of the first pixel is determined using a second coordinate of an upper pixel located above the first pixel and a third coordinate of a side pixel located at one side of the first pixel.

8. The apparatus for detecting a pixel distance according to claim 7, wherein the coordinate determination unit comprises:
a distance calculation unit, for calculating a second pixel distance which corresponds to a distance between the upper pixel and the minor pixel and a third pixel distance which corresponds to a distance between the side pixel and the minor pixel;
a distance comparison unit, for comparing the second pixel distance with the third pixel distance and outputting a comparison result; and
a coordinate-value designation unit for designating a transverse value of the third coordinate added by 1 as a transverse value of the first coordinate and designating a longitudinal value of the third coordinate as a longitudinal value of the first coordinate, or designating a transverse value of the second coordinate as a transverse value of the first coordinate and designates a longitudinal value of the second coordinate added by 1 as a longitudinal value of the first coordinate in response to the comparison result.
